(19) United States
(12) Patent Application Publication
(10) Pub. No.: US 2014/0258488 A1
(43) Pub. Date: Sep. 11, 2014

(54) MANAGING MOBILE DEVICES WITH A GENERAL PURPOSE MESSAGING TRANSPORT PROTOCOL

(71) Applicants: Shashank Mohan Jain, Karnataka (IN); Srinivasa Reddy Challa, Bangalore (IN)

(72) Inventors: Shashank Mohan Jain, Karnataka (IN); Srinivasa Reddy Challa, Bangalore (IN)

(73) Assignee: SAP AG, Walldorf (DE)

(21) Appl. No.: 13/794,289

(22) Filed: Mar. 11, 2013

(51) Int. Cl. H04L 12/58

(52) U.S. Cl. CPC H04L 51/046
USPC 709/223

(57) ABSTRACT

A system uses a general purpose messaging transport protocol to manage, control, and monitor a mobile communication device and/or a plurality of mobile communication devices.

### TECHNICAL FIELD

The present disclosure relates to managing mobile communication devices using a general purpose messaging transport protocol.

### BACKGROUND

Traditionally, mobile communication devices are managed using a Server/Client agent design paradigm. The server agent is configured to remotely control and monitor the mobile communication devices via a client agent deployed on smart phones. Such control and monitoring is particularly important for business organizations that have personnel deployed in the field with smart phones. However, current monitoring and control systems that use Server/Client agents are limited by scalability and cost factors. For bottom of the pyramid solutions, it would be helpful if there was a device management application for monitoring and controlling mobile communication devices that is scalable and low in cost.

### BRIEF DESCRIPTION OF THE DRAWINGS

FIGS. 1A and 1B are block diagrams of example embodiments of systems for using a general purpose messaging transport protocol for managing and controlling a plurality of mobile communication devices.

FIGS. 2A and 2B are a flowchart-like diagram illustrating steps and features of a process and a system for managing and controlling a plurality of mobile communication devices.

FIG. 3 is a block diagram of an example embodiment of a computer system in connection with which one or more embodiments of the present disclosure can execute.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

In an embodiment, the above-discussed difficulties in managing mobile devices are addressed by using, instead of the currently-used Server/Client agents, a general purpose messaging transport protocol such as Extensible Messaging and Presence Protocol (XMPP). As is known to those of skill in the art, XMPP is a communications protocol for message-oriented middleware based on XML (Extensible Markup Language). XMPP is a set of open technologies for instant messaging, multi-party chat, voice and video calls, collaboration, lightweight middleware, content syndication, and generalized routing of XML data. Because of its extensible design, it can also be used for publish-subscribe systems; signaling for VoIP (Voice over IP), video, and file transfer; gaming; and social networking services. Because of its open nature, anyone may implement an XMPP service and interoperate with other organizations' implementations of XMPP services. In addition to its open nature, the architecture of an XMPP network is similar to email. That is, anyone can run their own XMPP server, and there is no central master server.

Due in part to its open structure, custom functionalities can be built on top of an XMPP system or server. To maintain interoperability however, common extensions are managed by the XMPP Standards Foundation. As noted, such XMPP functionalities and applications beyond instant messaging include groupchat, network management, content syndication, collaboration tools, file sharing, gaming, remote systems control and monitoring, geo-location, middleware and cloud computing, VoIP, and identity services. XMPP is also used in deployments of non-IM services, including smart grid systems such as demand-response applications, message-oriented middleware, and as a replacement for short message service (SMS) to provide text messaging on many smartphone clients.

The XMPP Standards Foundation (or XSF) is active in developing open XMPP extensions. However, extensions can also be defined by any individual, software project, or organization. An example of an extension is the federation protocol in Apache Wave (the child of Google Wave), which is based on XMPP.

An XMPP network uses a client-server architecture (i.e., clients do not talk directly to one another). However, it is decentralized by design, since there is no central authoritative server, and as noted, anyone may run their own XMPP server on their own domain.

In an embodiment, an XMPP-based presence-enabled communication is created between a plurality of mobile communication devices and the XMPP server over transmission control protocol/internet protocol (TCP/IP). In a specific embodiment, the XMPP server uses Apache MINA (Multipurpose Infrastructure for Network Application) with non-blocking sockets to achieve a large scale and to support a large fleet of devices deployed remotely. The open source XMPP server implementation can scale up to 100,000 connections per node.

As is known to those of skill in the art, Apache MINA is an open source Java network application framework. MINA can be used to create scalable, high performance network applications. MINA provides unified application program interfaces (APIs) for various transports like TCP, UDP, and serial communication. It also makes it easy to make an implementation of custom transport type. MINA provides both high-level and low-level network APIs. A user application interacts with MINA APIs, shielding the user application from low level I/O details. This makes it easy for the users to concentrate on the application logic and leave the I/O handling to Apache MINA.

In using an XMPP server to monitor and control mobile communication devices, each mobile communication device has an XMPP client agent installed on it that, on startup of the mobile communication device, establishes a durable TCP connection with the XMPP server. The same TCP connection can be used for bidirectional socket communication. In effect, this means that the server and client agents can push information as well as receive information on the same socket.

The mobile communication devices receive commands over the established XMPP channel. The received commands from the XMPP server can include commands to lock/unlock the device, to write data to the device, to erase data from the device, to acquire health statistics of the device, and to install applications on the device. Additionally, the mobile communication device can send to the XMPP server geo-location data and snippets of error logs over the same channel that the XMPP server uses to transmit to the mobile communication device.

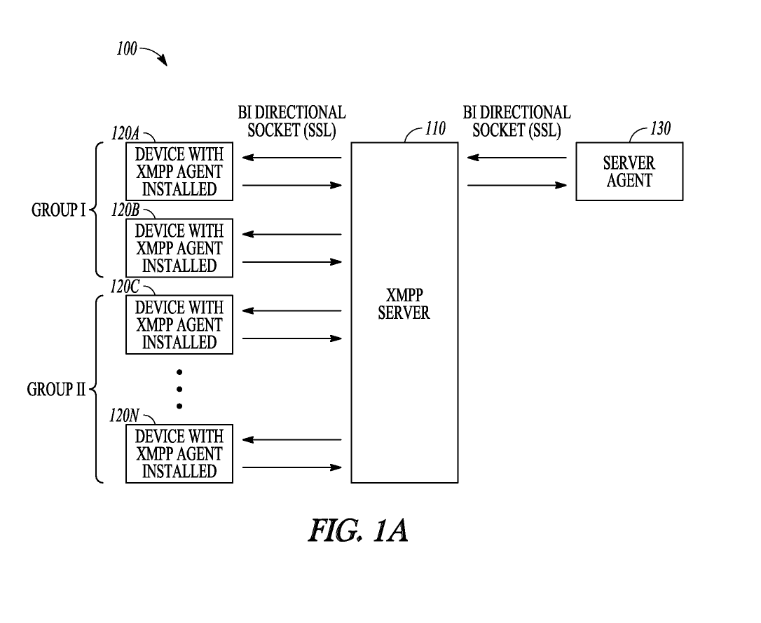

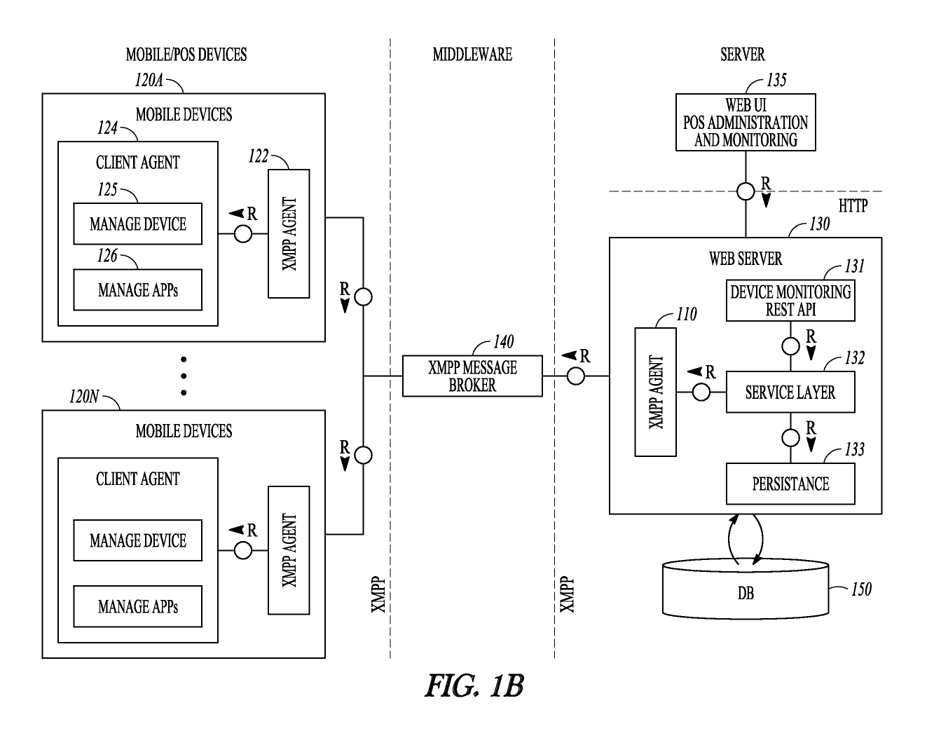

FIG. 1A is a block diagram illustrating an example embodiment of a system 100 that uses an XMPP server 110 to control and monitor a plurality of mobile communication devices 120A, 120B, 120C, and 120N. As illustrated in FIG. 1A, the XMPP server 110 and the mobile communication devices 120A, 120B, 120C, and 120N communicate via a bidirectional socket. The system 100 further includes a server agent 130, which connects to the XMPP server 110 via XMPP protocol. The server agent 130 is also abstracted to communicate using protocols other than XMPP. The server agent 130 is wholly responsible for sending the commands noted in the previous paragraph (e.g., commands to lock/unlock a device).

As further illustrated in FIG. 1A, the mobile communication devices can be aggregated into groups. For example, mobile communication devices 120A and 120B could be part of a Group I, and mobile communication devices 120C and 120N (and the mobile communication devices in between) could be part of a Group II. These groupings can be based on virtually any criteria, such as per company department, per employee position and pay scale, per years of service with the company, per type of application used by the employee, etc. In short, the groupings can be implemented so as to permit group-based communications, similar to email groups in an email system, and to allow updates to a group of devices.

FIG. 1B is a block diagram illustrating another example embodiment of a system that uses XMPP protocol to control and monitor a plurality of mobile communication devices. FIG. 1B illustrates the mobile device 120A in a little more detail. Specifically, the mobile device 120A includes a XMPP agent 122, and a client agent 124. The client agent 124 further includes a manage device module 125 and a manage apps module 126. An XMPP message broker 140 serves as middleware between the mobile devices and the servers. The server agent 130 includes the XMPP agent 110. The server agent 130 further includes a device monitoring REST API 131, a service layer 132, and a persistence module 133. The server agent 130 communicates with database 150, and is accessible via user interface 135.

In another embodiment, XMPP communications occur in a peer to peer fashion between devices. In such a peer to peer system, all devices can be given equal functionality, or one or more devices could be given additional supervisory authority, so as to monitor and control the other devices.

The system 100 can be deployed in connection with Androids, Apple's Iphone, or other smart phone platforms. The system can also be deployed in connection with mobile point of sale (POS) devices.

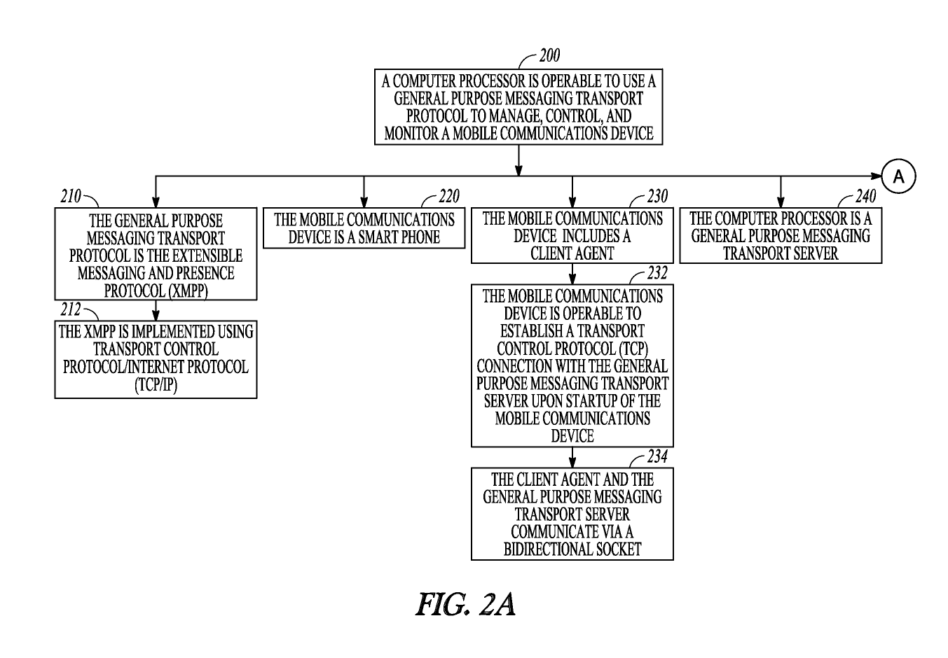

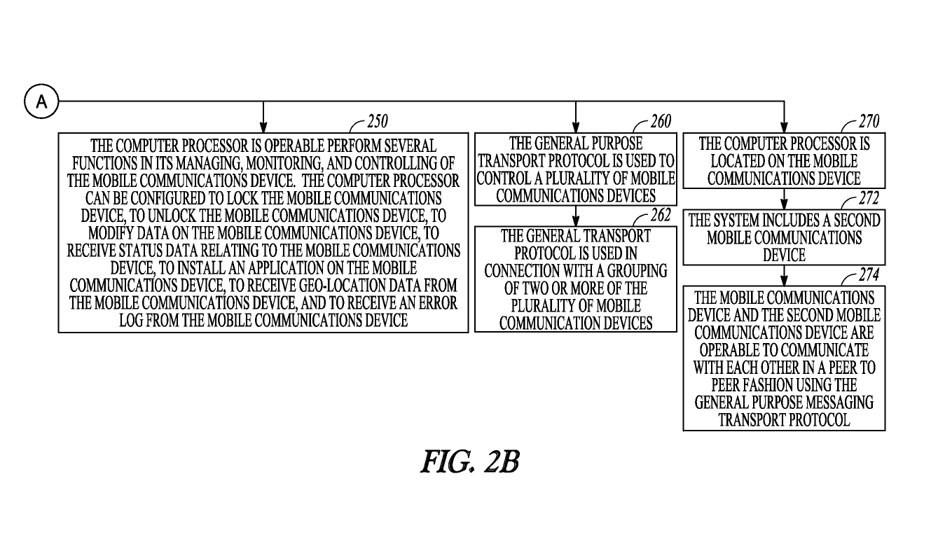

FIG. 2 is a block diagram illustrating steps and features of an example process and system for managing mobile communication devices using a general purpose messaging transport protocol. FIG. 2 includes a number of process blocks 200-274. Though arranged serially in the examples of FIG. 2, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring to FIG. 2, at 200, a computer processor is operable to use a general purpose messaging transport protocol to manage, control, and monitor a mobile communication device.

As noted at 210, the general purpose messaging transport protocol can be the Extensible Messaging and Presence Protocol (XMPP). As noted above, the XMPP is an open source architecture that permits scalability to many mobile communication devices. In an embodiment, as indicated at 212, the XMPP is implemented using transport control protocol/internet protocol (TCP/IP) with non-blocking sockets.

As indicated at 220, the mobile communication device can be a smart phone. The smart phone can be an Android smart phone, an iPhone by the Apple Corporation, or any other smart phone platform. The device could also be a mobile point of sale (POS) device.

Block 230 indicates that the mobile communication device can include a client agent. The client agent is configured to communicate with a general purpose message broker. As noted in block 210, the general transport messaging transport server/protocol can be an XMPP server/protocol. Additionally, block 232 shows that the mobile communication device is operable to establish a transport control protocol (TCP) connection with the general purpose message broker upon startup of the mobile communication device. Further, block 234 shows that the client agent and the general purpose message broker communicate via a bidirectional socket. The bidirectional socket permits the client agent on the mobile communication device and the general purpose message broker to entertain requests and responses to those requests. For example, the server agent via the message broker could request a health status of the mobile communication device, and the mobile communication device can respond with the status of the device.

Block 240 shows that the computer processor can include the general purpose message broker and additionally include a server agent component that is operable to communicate with the general purpose message broker.

Block 250 indicates that the computer processor is operable to perform several functions in its managing, monitoring, and controlling of the mobile communication device. For example, the computer processor can be configured to lock the mobile communication device, to unlock the mobile communication device, to modify data on the mobile communication device, to receive status data relating to the mobile communication device, to install an application on the mobile communication device, to receive geo-location data from the mobile communication device, and to receive an error log from the mobile communication device.

Block 260 shows that the general purpose transport protocol can be used to control a plurality of mobile communication devices. Additionally, at 262, the general transport protocol can be used in connection with a grouping of two or more of the plurality of mobile communication devices. As noted above, the grouping of the mobile communication devices can be according to any criteria (e.g., departments within a company), and used for any purpose (e.g., monitoring the costs associated with the plurality of mobile communication devices on a per company department basis).

Block 270 indicates that the computer processor can be located on the mobile communication device. Additionally, at 272, the system includes a second mobile communication device. At 274, the mobile communication device and the second mobile communication device are operable to communicate with each other in a peer to peer fashion using the general purpose messaging transport protocol. As noted above, one or more mobile communication devices can be configured to monitor and control the plurality of other mobile communication devices.

The following are sample code snippets to illustrate an example of using an XMPP protocol in requests/responses for locking a mobile communications device and requests/responses for determining memory usage in a mobile communications device.

```
//Server Request
{“requestType”:“action”
“ID”:“dff0a0dface647a3b6c9acba7a418abe”
“command”:“LOCK_DEVICE”
“data”: “”}
//Client Response
{“ID”:“dff0a0dface647a3b6c9acba7a418abe”
“response”: “success”}
//Request And Response for MemoryUsage
//Server Request
{“requestType”:“status”
“ID”:“dga0a0dface647a3b619acba7a418nbe”
“command”:“MEMEORY_USAGE”
“data”: “”}
//Client Response
{“ID”:“dff0a0dface647a3b6c9acba7a418abe”
“response”: “RAM=82% | SDCARD=45%”}
//server snippet
    //--------------
      //listener class to receive Server messages
      public MessageListener messagelistener;
      XMPPConnection connection;
        /**
        * Connects Server Agent to XMPP message broker
        */
        public void connect( ) throws Exception
        {
            ConnectionConfiguration config = new
ConnectionConfiguration(“50.112.250.11”,5222);
            connection = new XMPPConnection(config);
            connection.connect( );
            connection.login(“adminuser”, “adminpass”) ;
            connection.getChatManager( ).addChatListener(messagelistener);
        }
        /**
        * Method to process Client Message
        * @param clientAgent is handler for the agent(Client) that send the message
        * @param message
        */
        public void processMessage(Chat clientAgent, Message message) {
            String messageText = message.getBody( );
            Gson gson = new Gson( );
            ClientResponse clientResponse = gSon.fromJson(responseLine,
ClientResponse.class);
            //process Client response and store/report the response.
            processClientResponse(clientResponse);
        }
    //Client Snippet
    //--------------
      //listener class to receive Server messages
      public MessageListener messagelistener= new MessageListener( ) ;
      /**
        * Connects Client Agent to XMPP message broker
        */
        public void Connect( )
        {
            ConnectionConfiguration config = new ConnectionConfiguration(“50.112.250.11”,
5222);
            config.setTruststoreType(“BKS”);
            SmackConfiguration.setKeepAliveInterval(10000);SmackConfiguration.setPacket
ReplyTimeout(30000);
            connection = new XMPPConnection(config);
            try {
                connection.connect( );
                connection.login(user,password);
            } catch (XMPPException e) {
            e.printStackTrace( );
            }
            Presence presence = new Presence(Presence.Type.available);
            connection.sendPacket(presence);
            //attache message listener to commands from server
            connection.getChatManager( ).createChat(“adminuser@domain”, mlistener);
        }
        /**
        * Method to Process Server Request
        * @param serverAgent is handler for the agent(server) that send the message
        * @param message
        */
        public void processMessage(Chat serverAgent, Message message) {
            String messageText = message.getBody( );
            Gson gson = new Gson( );
            ServerRequest serverRequest = gSon.fromJson(responseLine, ServerRequest.class);
            if(serverRequest.getRequestType(“action”))
            {
                handleActionRequest(serverAgent,serverRequest);
            }
            else if(serverRequest.getRequestType(“status”))
            {
                handleStatusRequest(serverAgent,serverRequest);
            }
            else if(serverRequest.getRequestType(“sync”))
            {
                handleSyncRequest(serverAgent,serverRequest);
            }
        }
```

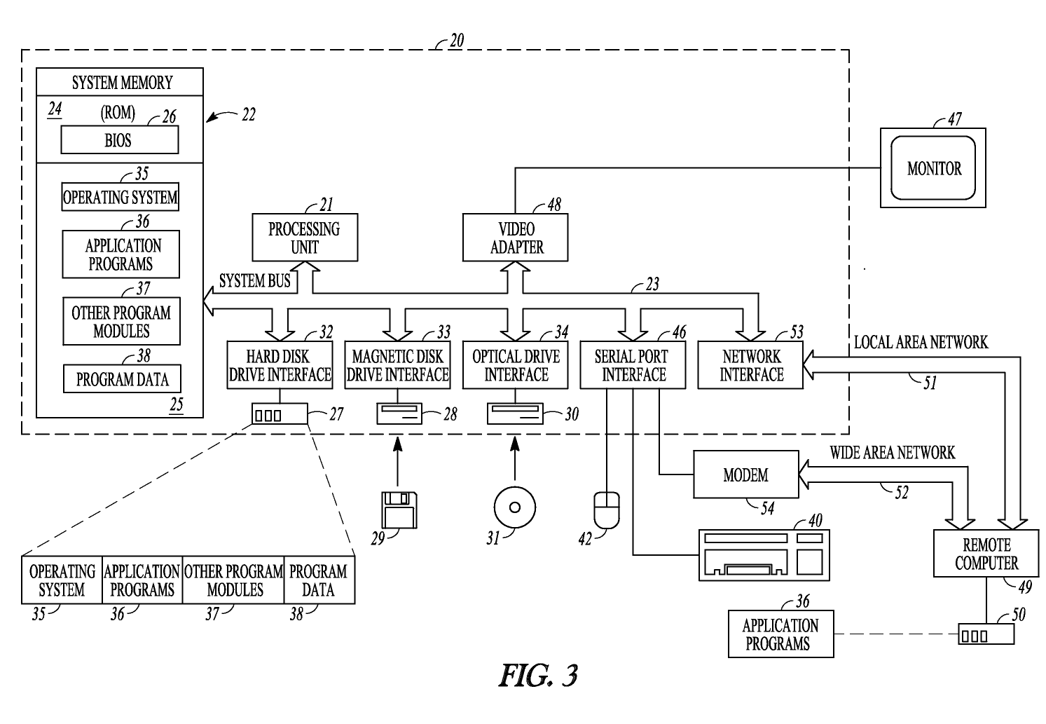

FIG. 3 is an overview diagram of hardware and an operating environment in conjunction with which embodiments of the invention may be practiced. The description of FIG. 3 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCs, minicomputers, mainframe computers, and the like. The invention may also be practiced in distributed computer environments where tasks are performed by I/O remote processing devices that are linked through a communications network. In a distributed computing environment, program modules may be located in both local and remote memory storage devices.

In the embodiment shown in FIG. 3, a hardware and operating environment is provided that is applicable to any of the servers and/or remote clients shown in the other Figures.

As shown in FIG. 3, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. A multiprocessor system can include cloud computing environments. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 47 can display a graphical user interface for the user. In addition to the monitor 47, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/O relative to the computer 20, although only a memory storage device 50 has been illustrated. The logical connections depicted in FIG. 3 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1. A system comprising:
a computer processor operable to:
use a general purpose messaging transport protocol to manage, control, and monitor a mobile communication device.

2. The system of claim 1, wherein the general purpose messaging transport protocol comprises Extensible Messaging and Presence Protocol (XMPP).

3. The system of claim 2, wherein the XMPP is implemented using transport control protocol/internet protocol (TCP/IP) with non-blocking sockets.

4. The system of claim 1, wherein the mobile communication device comprises one or more of a smart phone and a point of sale (POS) device.

5. The system of claim 1, wherein the mobile communication device comprises a client agent that is operable to communicate with a general purpose message broker.

6. The system of claim 5, wherein the mobile communication device is operable to establish a transport control protocol (TCP) connection with the general purpose message broker upon startup of the mobile communication device.

7. The system of claim 5, wherein the client agent and the general purpose message broker establish a bidirectional socket.

8. The system of claim 1, wherein the computer processor comprises a general purpose message broker and a server agent component that is operable to communicate with the general purpose message broker.

9. The system of claim 1, wherein the computer processor is operable to lock the mobile communication device, unlock the mobile communication device, modify data on the mobile communication device, receive status data relating to the mobile communication device, install an application on the mobile communication device, receive geo-location data from the mobile communication device, and receive an error log from the mobile communication device.

10. The system of claim 1, wherein the general purpose transport protocol is operable to control a plurality of mobile communication devices; and wherein two or more of the plurality of mobile communication devices are associated with a group of mobile communication devices.

11. The system of claim 1, wherein the computer processor is located on the mobile communication device, and the system comprises a second mobile communication device, wherein the mobile communication device and second mobile communication device are operable to communicate with each other in a peer to peer fashion using the general purpose messaging transport protocol.

12. A process comprising:
using a general purpose messaging transport protocol to manage, control, and monitor a mobile communication device.

13. The process of claim 12, wherein the general purpose messaging transport protocol comprises Extensible Messaging and Presence Protocol (XMPP); and wherein the XMPP is implemented using transport control protocol/internet protocol (TCP/IP) with non-blocking sockets.

14. The process of claim 12, wherein the mobile communication device comprises one or more of a smart phone and a point of sale (POS) device.

15. The process of claim 12, wherein the mobile communication device comprises a client agent that is operable to communicate with a general purpose message broker; wherein the mobile communication device is operable to establish a transport control protocol (TCP) connection with the general purpose message broker upon startup of the mobile communication device; and wherein the client agent and the general purpose message broker establish a bidirectional socket.

16. The process of claim 12, wherein the managing, controlling, and monitoring of the mobile communication device comprises locking the mobile communication device, unlocking the mobile communication device, modifying data on the mobile communication device, receiving status data relating to the mobile communication device, installing an application on the mobile communication device, receiving geo-location data from the mobile communication device, and receiving an error log from the mobile communication device.

17. The process of claim 12, comprising controlling a plurality of mobile communication devices with the general purpose transport protocol; wherein two or more of the plurality of mobile communication devices are associated with a group of mobile communication devices.

18. The process of claim 12, wherein the mobile communication device communicates with a second mobile communication device in a peer to peer fashion using the general purpose messaging transport protocol.

19. The process of claim 18, wherein the communication between the mobile communication device and the second mobile communication device comprises the mobile communication device managing, controlling, and monitoring the second mobile communications device.

20. A computer readable medium comprising instructions that when executed by a processor execute a process comprising:
using a general purpose messaging transport protocol to manage, control, and monitor a mobile communication device.
